(19) United States
(12) Patent Application Publication
(10) Pub. No.: US 2007/0156930 A1
(43) Pub. Date: Jul. 5, 2007

(54) METHOD FOR CONTROLLING DATA TRANSMISSION AND RELATED DEVICE

(76) Inventors: Peng-Jen Chen, Miao- Li Hsien (TW); Shih-Chang Hu, Hsin-Chu Hsien (TW)

Correspondence Address: NORTH AMERICA INTELLECTUAL PROPERTY CORPORATION, P.O. BOX 506, MERRIFIELD, VA, 22116, US

(21) Appl. No.: 11/306,503

(22) Filed: Dec. 30, 2005

(51) Int. Cl. G06F 3/00

(52) U.S. Cl. 710/14

(57) ABSTRACT

The invention relates to a method for controlling a data transmission between a peripheral device and a host. The method includes: estimating a transmission time of a predetermined amount of data transmitted between the peripheral device and the host; and determining a control scheme to be a polling scheme or an interrupt scheme according to the estimated transmission time for monitoring the data transmission between the peripheral device.

### BACKGROUND

The invention relates to a controlling method and more particularly to a method for controlling data transmission.

When a predetermined amount of data is transmitted between a memory of a host and a memory of a peripheral device, two approaches, a polling scheme and an interrupt scheme, may be utilized by the host to determine if the transmission is completed or not. If the polling scheme is utilized, the microprocessor of the host sends query commands to the peripheral device until a response to a query command signifies that the transmission is completed. If the interrupt scheme is utilized, the microprocessor of the host is capable of executing other tasks when transmitting data, and the peripheral device sends an interrupt signal to the host when the transmission is completed. After the host receives the interrupt signal, the microprocessor must determines the meaning of the interrupt signal first, records the status of the task currently executed, and then completes the task of data transmission.

In summary, the time for performing the polling scheme is shorter, but the task of data transmission occupies the microprocessor of the host until the transmission is completed. Compared with the polling scheme, the procedure of the interrupt scheme is more complex and takes more time, but the microprocessor of the host is capable of executing other tasks when transmitting data.

### SUMMARY

It is therefore an objective of the present invention to provide a method for controlling a data transmission between a peripheral device and a host, so as to dynamically select a proper control scheme from the polling scheme and the interrupt scheme.

According to the claimed invention, a method for controlling a data transmission between a peripheral device and a host is disclosed. The method comprises: estimating a transmission time of a predetermined amount of data transmitted between the peripheral device and the host; and determining a control scheme to be a polling scheme or an interrupt scheme according to the estimated transmission time for monitoring the data transmission between the peripheral device.

According to the claimed invention, an electronic device is disclosed. The electronic device comprises: a microprocessor; and a storage device, coupled to the microprocessor, for storing a first program code and a second program code, the first program code executed by the microprocessor being utilized for estimating a transmission time of a predetermined amount of data transmitted between the peripheral device and the host and it should be done only one time during the device initialization, the second program code executed by the microprocessor being utilized for determining a control scheme to be a polling scheme or an interrupt scheme according to the estimated transmission time for monitoring a data transmission between a peripheral device and the electronic device.

The present invention selectively utilizes the polling scheme or the interrupt scheme according to the transmission time to minimize the disadvantages of the two control schemes. As a result, the efficiency of the microprocessor is significantly improved.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a flow chart of the method for controlling a data transmission between a peripheral device and a host according to a first embodiment of the present invention.

FIG. 2 is a schematic diagram of an electronic device utilizing the method to control a data transmission according to the present invention.

### DETAILED DESCRIPTION

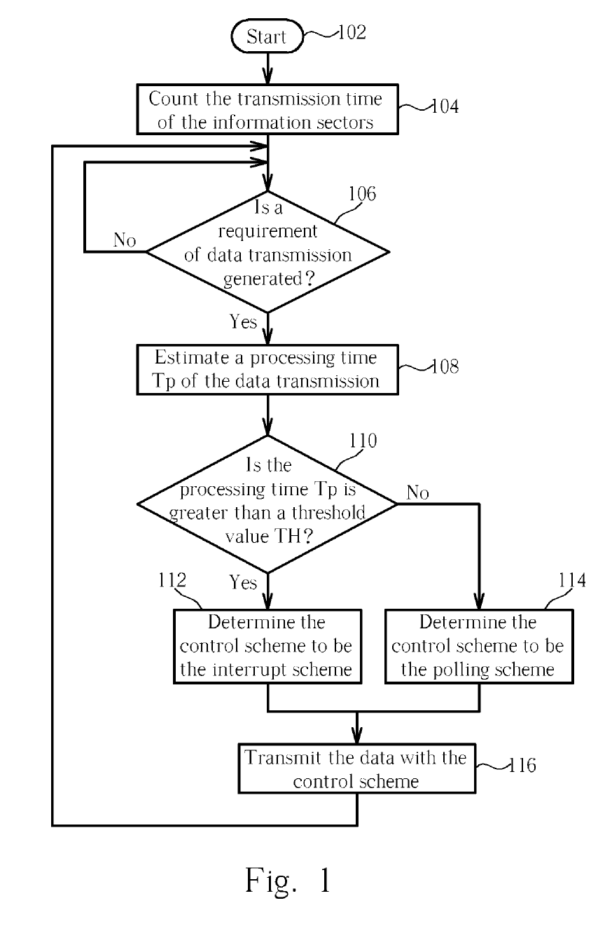

Please refer to FIG. 1. FIG. 1 is a flow chart of the method for controlling a data transmission between a peripheral device and a host according to a first embodiment of the present invention. The method comprises the following steps:

Step 102: Start.

Step 104: Initialize the peripheral device, and calculate the unit transmission time Tn by reading the plurality of information sectors stored in the peripheral device, and record it for future usage (to estimate the total data transmission time Tp=Tn×N where N means number of units).

Step 106: If a requirement of data transmission between the host and the peripheral device is triggered, proceed to step 108, otherwise, go back to step 106.

Step 108: Estimate a processing time Tp of the data transmission according to the transmission time and the data amount to be transmitted between the host and the peripheral device.

Step 110: If the processing time Tp is greater than a threshold value TH, proceed to step 112; otherwise, proceed to step 114.

Step 112: Determine the control scheme to be the interrupt scheme and proceed to step 116.

Step 114: Determine the control scheme to be the polling scheme and proceed to step 116.

Step 116: Transmit the data utilizing the control scheme, and return to step 106.

In the present embodiment, the peripheral device is a memory card, but the application of the present invention is not limited by the present embodiment. When the memory card is enabled, the host reads the information sectors (e.g. MBR and PBR) stored in the memory card, and counts the transmission time of the information sectors. Since the size of the information sectors is predetermined, the transmission time and the size of the information sectors are utilized to calculate the transmission speed between the memory card and the host. When a requirement of data transmission is triggered, the host estimates a processing time Tp of the data transmission by multiplying the transmission speed by the data amount to be transmitted. The host then selects the control scheme from the interrupt scheme and the polling scheme according to the processing time Tp.

In the first embodiment, a threshold value TH is determined according to a time interval permitted to occupy the microprocessor of the host. Since the interrupt scheme occupies the microprocessor when the data is transmitted, the host determines the control scheme to be the interrupt scheme if the processing time Tp is greater than the threshold value TH. However, if the processing time Tp is not greater than the threshold value TH, the host determines the control scheme to be the polling scheme. Afterwards, the host transmits the data with the determined control scheme.

According to a second embodiment of the present invention, the threshold value TH is determined according to the latency of the interrupt scheme. When the microprocessor receives an interrupt signal, the microprocessor must perform a context switch at least three times. As a result, if the ratio of the processing time Tp to the time interval for performing a context switch three times is greater than a predetermined ratio (e.g. “1”), the host determines the control scheme to be the interrupt scheme, otherwise, the host determines the control scheme to be the polling scheme. Therefore, the threshold value TH is determined to be the predetermined ratio (e.g. “1”) divided by the time interval for performing a context switch by a number of times according to the second embodiment.

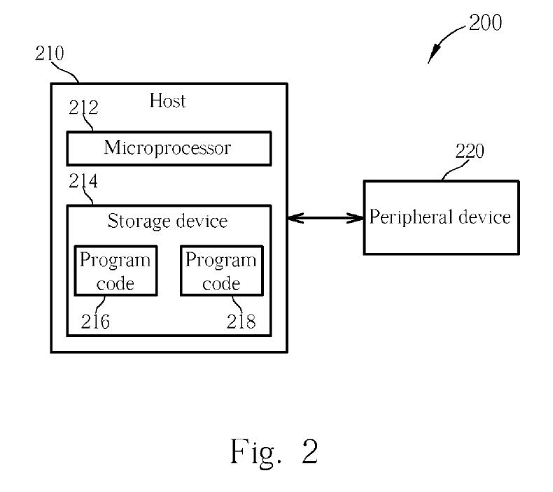

Please refer to FIG. 2. FIG. 2 is a schematic diagram of an electronic device 200 utilizing the method for controlling a data transmission according to the present invention. As shown in FIG. 2, the electronic device 200 includes a host 210 and a peripheral device 220. The host 210 comprises a microprocessor 212 and a storage device 214. The storage device 214 stores two program codes 216, 218. The program code 216 is executed to estimate the transmission time Tp of a predetermined amount of data transmitted between the peripheral device and the host, and the program code 218 is executed to determine the control scheme to be a polling scheme or an interrupt scheme according to the transmission time Tp for monitoring a data transmission between a peripheral device and the electronic device.

Compared with the related art, the present invention selects the control scheme from the interrupt scheme and the polling scheme according to the processing time. The present invention determines a threshold value according to the time interval permitted to occupy the microprocessor or the time interval for performing a context switch three times, compares the processing time with the threshold value, and then determines the control scheme according to the comparison result. Since the polling scheme and the interrupt scheme are selectively utilized, the efficiency of the microprocessor is improved significantly.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for controlling a data transmission between a peripheral device and a host, the method comprising:
estimating a transmission time of a predetermined amount of data transmitted between the peripheral device and the host; and
determining a control scheme to be a polling scheme or an interrupt scheme, according to the estimated transmission time, for monitoring the data transmission between the peripheral device.

2. The method of claim 1, wherein the peripheral device is a memory card.

3. The method of claim 1, wherein the step of determining the control scheme comprises:
estimating a processing time of the data transmission according to the transmission time and a data amount to be transmitted between the host and the peripheral device;
if the processing time is greater than a threshold value, determining the control scheme to be the interrupt scheme; and
if the processing time is not greater than the threshold value, determining the control scheme to be the polling scheme.

4. The method of claim 3, wherein the threshold value is determined according to latency for performing the interrupt scheme.

5. The method of claim 4, wherein the latency is computed by multiplying a time interval for performing a context switch and a number of times of performing the context switch.

6. The method of claim 3, wherein the threshold value is set according to a time interval permitted to occupy all computing resources of the host.

7. The method of claim 1, wherein the host is a mobile handset or a personal digital assistant (PDA).

8. An electronic device, comprising:
a microprocessor; and
a storage device, coupled to the microprocessor, for storing a first program code and a second program code, the first program code executed by the microprocessor being utilized for estimating a transmission time of a predetermined amount of data transmitted between the peripheral device and the host, the second program code executed by the microprocessor being utilized for determining a control scheme to be a polling scheme or an interrupt scheme according to the estimated transmission time for monitoring a data transmission between a peripheral device and the electronic device.

9. The electronic device of claim 8, wherein the peripheral device is a memory card.

10. The electronic device of claim 8, wherein when the first program code is executed by the microprocessor, a processing time of the data transmission is estimated according to the transmission time and a data amount to be transmitted between the host and the peripheral device, if the processing time is greater than a threshold value, the control scheme is determined to be the interrupt scheme; and if the processing time is not greater than the threshold value, the control scheme is determined to be the polling scheme.

11. The electronic device of claim 10, wherein the threshold value is determined according to latency for the microprocessor performing the interrupt scheme.

12. The electronic device of claim 11, wherein the latency is computed by multiplying a time interval for the microprocessor performing a context switch and a number of times of performing the context switch.

13. The electronic device of claim 10, wherein the threshold value is set according to a time interval permitted to occupy the microprocessor of the host.

14. The electronic device of claim 8, wherein the host is a mobile handset or a personal digital assistant (PDA).
